(19) United States
(12) Patent Application Publication
(10) Pub. No.: US 2005/0169541 A1
(43) Pub. Date: Aug. 4, 2005

(54) Image signal processing apparatus and image signal processing method

(75) Inventor: Toshio Nakakuki, Mizuho-shi (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 11/028,917

(22) Filed: Jan. 4, 2005

(30) Foreign Application Priority Data
Jan. 29, 2004 (JP) 2004-21204

(51) Int. Cl. G06K 9/36

(52) U.S. Cl. 382/232

(57) ABSTRACT

To provide an image signal processing apparatus including an image signal receiving circuit 26 for receiving continuous image signals for every horizontal line, an image signal processing circuit 30 for reading image data from a memory block 28 and collectively applying processing to the image data for a predetermined number of at least two or more horizontal lines, the memory block 28 including a memory unit having a capacity capable of storing and holding the image data for horizontal lines obtained by adding at least 1 to the predetermined number, and a memory control circuit 24 for storing an image signal in the memory block 28 as image data. In the image signal processing circuit 30, each time the processing for the image data held in memory units for one horizontal line is completed, the memory control circuit 24 stores an image signal newly received in the image signal receiving circuit 26 in a memory unit in which the image data processed by the image signal processing circuit 30 is stored.

### CROSS-REFERENCE TO RELATED APPLICATION

The entire disclosure of Japanese Patent Application No. 2004-21204 including specification, claims, drawings, and abstract is incorporated herein by reference.

### BACKGROUND OF THE INVENTION

1. Field of the Invention

The present invention relates to an image signal processing apparatus and an image signal processing method for applying signal processing to a plurality of horizontal lines.

2. Description of the Related Art

Signal processing for a digitized image signal includes processing, such as, for example, JPEG processing, in which it is necessary to collectively apply signal processing to a plurality of horizontal lines. In general, an image signal is input in the circuit for processing the image signal in horizontal line units. Therefore, when collectively processing the image data over a plurality of horizontal lines, it is necessary to prepare a line memory having a capacity capable of accumulating the data for a plurality of horizontal lines.

For example, when applying the JPEG-type compression processing to an image signal, discrete sine conversion processing (DCT processing) is applied to an image signal comprising 8 longitudinal pixels×8 transverse pixels. FIG. 12 shows a circuit for applying the JPEG processing to a luminance signal (Y) of an image signal in real time. As shown in FIG. 12, the circuit comprises an image signal receiving circuit 10, a memory control circuit 12, memory blocks 14a and 14b, and a JPEG processing circuit 16. The memory blocks 14a and 14b respectively include a memory capable of accumulating the data for image signals for 8 horizontal lines serving as a processing unit of the JPEG processing. The image signal receiving circuit 10 receives a luminance signal (Y) from an external unit for every horizontal line. By outputting a switching signal S for switching changeover switches, the memory control circuit 12 performs control so that only either of the memory blocks 14a and 14b is connected to the image signal receiving circuit 10 and JPEG processing circuit 16. Moreover, the circuit 12 controls data write or data read of an image signal in or from the memory blocks 14a and 14b. Thereby, a luminance signal received by the image signal receiving circuit 10 is stored and held by either of the memory blocks 14a and 14b connected with the image signal receiving circuit 10. The JPEG processing circuit 16 sequentially reads data from the memory block 14a or 14b connected with the JPEG processing circuit 16 for every 8 longitudinal pixels×8 transverse pixels and the JPEG-type compression processing is executed for every 8 longitudinal pixels and 8 transverse pixels. The same processing is also applied to color difference signals (Cb and Cr).

As described above, in the case of a conventional image JPEG processing circuit, at least two memory blocks capable of accumulating image signals equivalent to the number of horizontal lines serving as the processing unit to be collectively processed are prepared to realize real-time image signal processing by switching these memory blocks.

In related art such as that described above, however, it is necessary to prepare a memory block having a capacity two times than the image data equivalent to the number of horizontal lines serving as a processing unit. Therefore, it is necessary to prepare a memory capacity two or more times than when the real time processing is not required. When increasing the memory capacity like this, a circuit scale is increased, which leads directly to increased manufacturing costs.

### SUMMARY OF THE INVENTION

The present invention advantageously provides an image signal processing apparatus for receiving image signals continuously transmitted for every horizontal line and collectively applying processing to at least a portion of image data in at least a predetermined number of two or more horizontal lines, which includes an image signal receiving circuit for receiving the image signals, a memory including the memory unit of a capacity capable of storing and holding the image data equivalent to at least horizontal lines obtained by adding 1 to the predetermined number of horizontal lines, a memory control circuit for storing the image signals received by the image signal receiving circuit in the memory as image data, and an image signal processing circuit for reading the image data from the memory and processing the data and each time the processing for the image data corresponding to the memory capacity for one horizontal line is completed in the image signal processing circuit, the memory control circuit stores an image signal newly received by the image signal receiving circuit in the memory unit in which the image data processed by the image signal processing circuit is stored.

The present invention also advantageously provides an image signal processing method for receiving image signals continuously transmitted for every horizontal line and collectively applying processing to at least a part of the image data in a predetermined number of at least two or more horizontal lines, in which a newly-received image signal is stored in the memory unit in which the processed image data is stored each time the processing for the image data corresponding to the memory capacity for one horizontal line is completed by using a memory including the memory unit of a capacity capable of storing and holding the image data for horizontal lines obtained by adding 1 to the predetermined number of horizontal lines.

### BRIEF DESCRIPTION OF THE DRAWINGS

Preferred embodiments of the present invention will be described in further detail based on the following drawings, wherein:

FIG. 1 is a block diagram showing a configuration of an image signal processing apparatus according to an embodiment of the present invention;

FIG. 2 is an illustration showing a configuration of a memory block of an image signal processing apparatus according to the embodiment of the present invention;

FIG. 3 is an illustration showing a flowchart of an image signal processing method of the embodiment of the present invention;

FIG. 4 is an illustration for explaining grouping of memory units in the embodiment of the present invention;

FIG. 5 is an illustration for explaining the storage processing of image data to a memory unit in the embodiment of the present invention;

FIG. 6 is an illustration for explaining the allocation processing of tags of a memory block and storage processing of image data in the embodiment of the present invention;

FIG. 7 is an illustration for explaining the image processing in the embodiment of the present invention;

FIG. 8 is an illustration for explaining the re-allocation processing of tags in the embodiment of the present invention;

FIG. 9 is the allocation processing of tags and the storage processing of new image data in the embodiment of the present invention;

FIG. 10 is an illustration for explaining the allocation processing of tags of a memory block and the storage processing of new image data in the embodiment of the present invention;

FIG. 11 is an illustration for explaining the allocation processing of tags of a memory block and the storage processing of new image data in the embodiment of the present invention; and

FIG. 12 is a block diagram showing a configuration of an image signal processing apparatus in the background art.

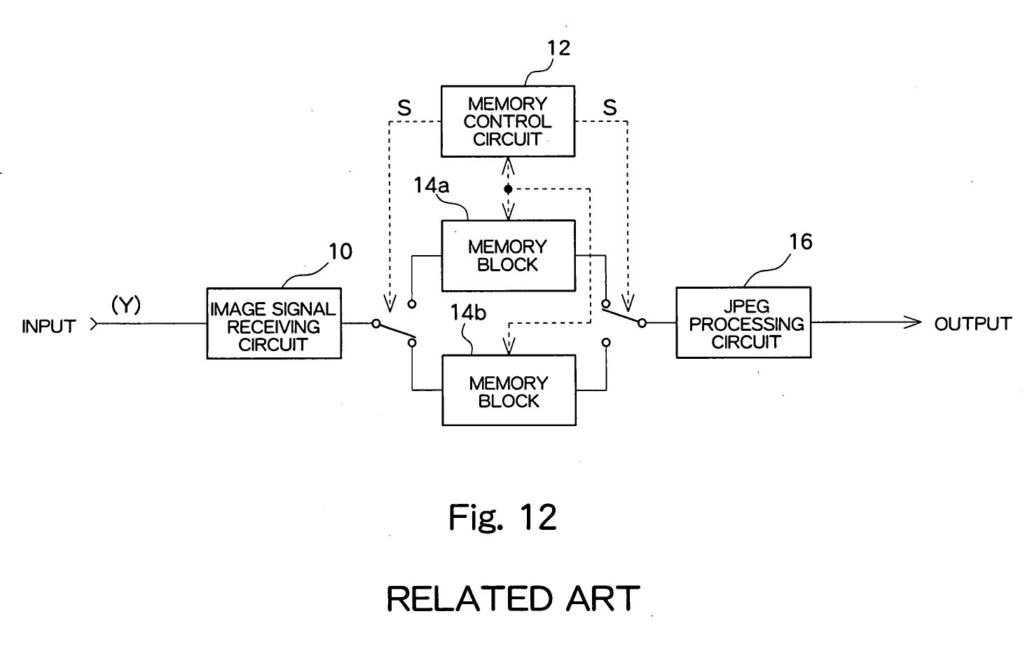

### DESCRIPTION OF THE PREFERRED EMBODIMENTS

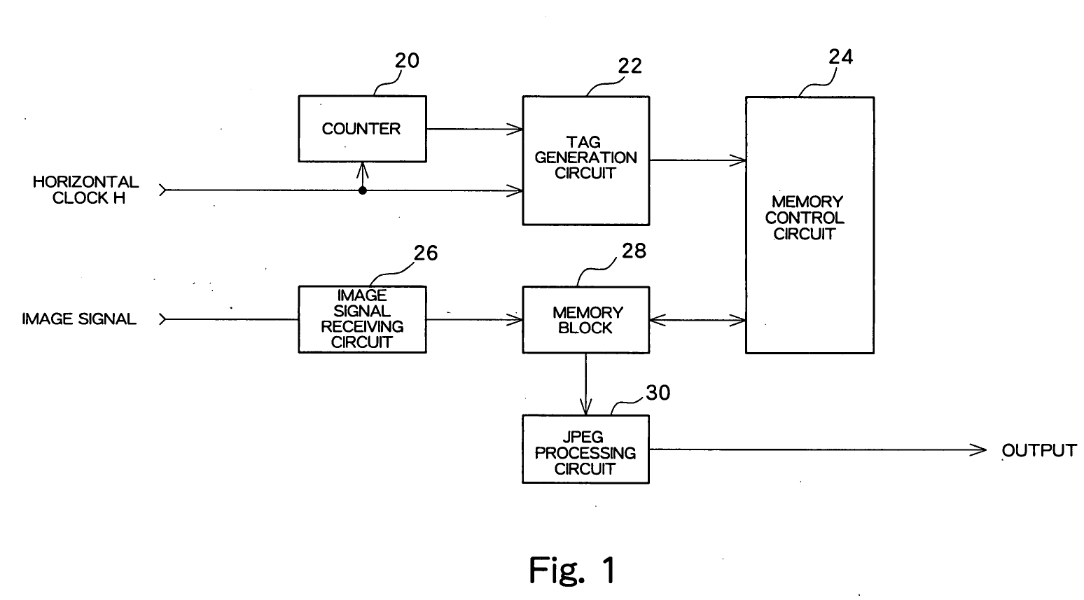

As shown in FIG. 1, an image signal processing apparatus according to a preferred embodiment of the present invention includes a counter 20, a tag generation circuit 22, a memory control circuit 24, an image signal receiving circuit 26, a memory block 28, and a JPEG processing circuit 30. The counter 20, tag generation circuit 22, memory control circuit 24, and JPEG processing circuit 30 can be realized by a microcomputer including a register and the like. The following description is based on an example wherein the JPEG processing circuit 30 executes the JPEG processing for an image signal of 8 longitudinal pixels×8 transverse pixels. The scope of this embodiment is not restricted to this configuration, and processing can be applied as long as the processing is processing to be collectively applied to at least a portion of the image data in each of a plurality of horizontal lines.

An image signal is input to the image signal processing apparatus from the outside of the apparatus for every horizontal line. Moreover, a horizontal clock H showing the beginning of each horizontal line of the image signal is input. The image signal is input to the image signal receiving circuit 26 and the horizontal clock H is input to the tag generation circuit 22.

The counter 20 is a four-bit counter. The counter 20 increases a counter value in increments of one, each time the horizontal clock H showing the beginning of one horizontal line of the image signal is received, and repeatedly counts from 1 to 16. The count value of the counter 20 is output to the tag generation circuit 22.

The tag generation circuit 22 receives the count value of the counter 20 and the horizontal clock H to generate a tag. The tag generated by the tag generation circuit 22 is used to specify a group of the memory unit included in the memory block 28 in the access control of image data to the memory in the memory control circuit 24. Generation of a tag will be described in detail below.

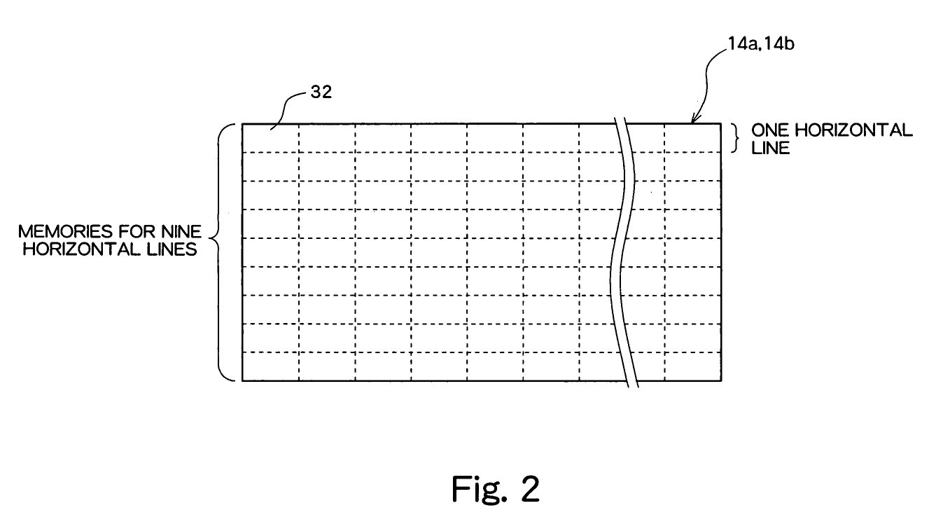

The image signal receiving circuit 26 receives an image signal from an external unit and outputs it to the memory block 28. In the case of a color image, it is preferable that the image signal be divided into a luminance signal (Y) and color difference signals (Cb and Cr) before being input. The memory block 28 comprises a plurality of memory units, each memory unit being a unit of storage capacity corresponding to the storage capacity required for storing image data showing the luminance signal (Y) and color difference signals (Cb and Cr) for one pixel. For example, when the luminance signal (Y) for one pixel is shown by 8-bit data, one memory unit has a storage capacity of 8 bits. The memory block 28 is constituted by including memory unit for storing the image data for horizontal lines which must be collectively processed by the JPEG processing circuit 30 and the image data for one more horizontal line. For example, when applying JPEG-type compression processing to a pixel group of 8 longitudinal pixels×8 transverse pixels by the JPEG processing circuit 30 for an image signal in which one horizontal line is constituted by 64 pixels, the memory block 28 is constituted by including a plurality of memory units 32 capable of accumulating the image data for at least 64 pixels×9 horizontal lines as shown in FIG. 2.

The memory control circuit 24 receives a tag from the tag generation circuit 22 and writes an image signal in the memory unit 32 specified by the tag. The processing in the memory control circuit 24 will be described below. The JPEG processing circuit 30 reads the image signal data from the memory block 28 and compresses the data in accordance with the JPEG type.

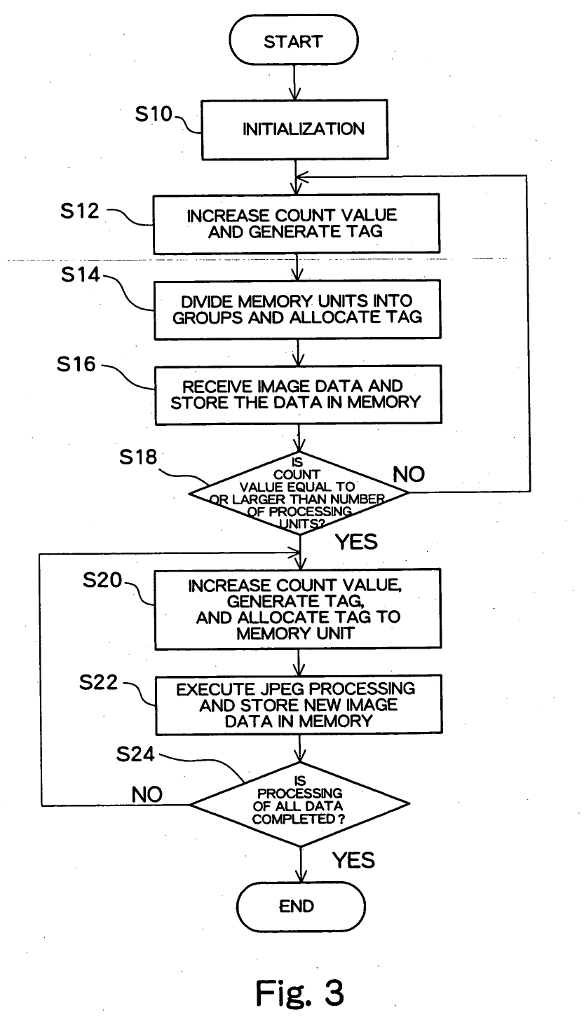

In the image signal processing apparatus of this embodiment, image signal data is stored in the memory block 28 and the image signals stored in the memory block 28 are processed in accordance with the flowchart shown in FIG. 3.

At step S10, initialization is executed. In the case of the initialization, the count value of the counter 20 is set to 0 and all memory units 32 in the memory block 28 are reset. When a horizontal clock is input to the counter 20, processing is changed to step S12.

At step S12, the count value of the counter 20 is increased by 1. At the same time, the tag generation circuit 22 receives a horizontal clock and the count value of the counter 20 to sequentially generate a tag shown by a combination of [count value]-(group number). This tag is used to specify each group of the memory units 32 in the memory block 28. A group number is a positive integer of 1 or more and the group number is provided from 1 to the number of horizontal lines to be collectively processed by the JPEG processing circuit 30. For example, when the image data of 8 longitudinal pixels×8 transverse pixels is collectively processed by the JPEG processing circuit 30, because the number of horizontal lines serving as units to be collectively processed is 8, 8 tags are sequentially generated as [1]-(1), [1]-(2), and [1]-(8).

In step S14, the memory units 32 of the memory block 28 are divided into groups and a tag is allocated to each group. The memory control circuit 24 receives tags from the tag generation circuit 22, selects empty memory units 32 in which image data is not stored from the memory block 28, group the units 32, and allocates tags. In this case, it is preferable to allocate a specific tag for every group to perform memory management by forming the memory unit group in which the image data for each horizontal line is stored into one group for every memory units of the number obtained by dividing the number of pixels included in one horizontal line by a predetermined number, that is, the number of horizontal lines to be collectively processed by an image signal processing circuit. It is preferable that a tag is constituted by a combination of a number for specifying each horizontal line and a group number for specifying each group. In this case, the memory units 32 of the number obtained by dividing the number of pixels included in one horizontal line by the number of horizontal lines to be collectively processed by the JPEG processing circuit 30 is formed into one group and tags generated at step S12 are sequentially allocated to each group one by one.

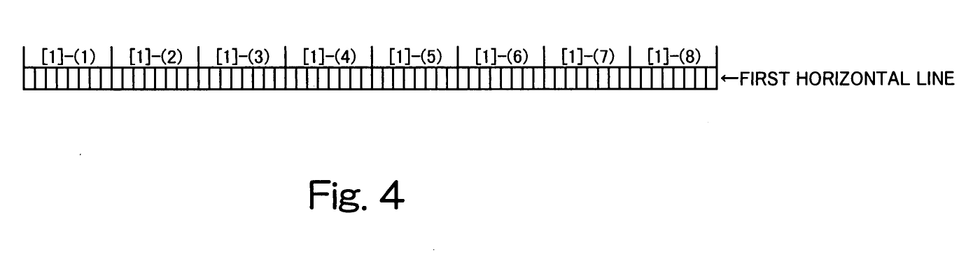

For example, when one horizontal line is constituted by 64 pixels and the image data of 8 longitudinal pixels×8 transverse pixels is collectively compressed by the JPEG processing circuit 30, the memory units 32 for 8 pixels obtained by dividing 64 pixels of one horizontal line by 8 horizontal lines to be collectively processed are formed into one group and one tag is sequentially allocated to 8 groups. The memory units 32 for 64 pixels of one horizontal line is divided into 8 groups and each group is specified by a counted value for specifying each horizontal line and a specific tag having a group number for specifying the sequence from the head of each horizontal line. For example, when a count value is 1, the memory units 32 for 64 pixels of one horizontal line are divided into 8 groups for every 8 pixels as shown in FIG. 4. The memory units 32 are specified by tags [1]-(1) to [1]-(8).

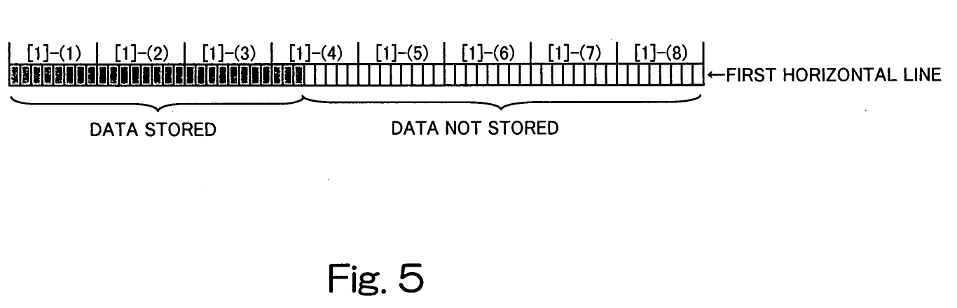

New image data is received by the image signal receiving circuit 26 at step S16 and the image data received by the memory units 32 included in a group to which a tag is allocated at step S14 are sequentially stored. In this case, as shown in FIG. 5, image data is sequentially stored from the memory unit 32 included in the group to which a tag having a small count value and group number is allocated.

At step S18, it is determined whether the count value of the counter 20 reaches up to the number of horizontal lines serving as a processing unit. In the case of the JPEG processing using 8 longitudinal pixels×8 transverse pixels as a processing unit, the number of horizontal lines serving as a processing unit is 8. Therefore, it is determined whether the count value is 8 or more. When the count value is the number of horizontal lines serving as a processing unit or more, processing goes to S20. When the count value is less than the number of horizontal lines serving as a processing unit, processing returns to S12.

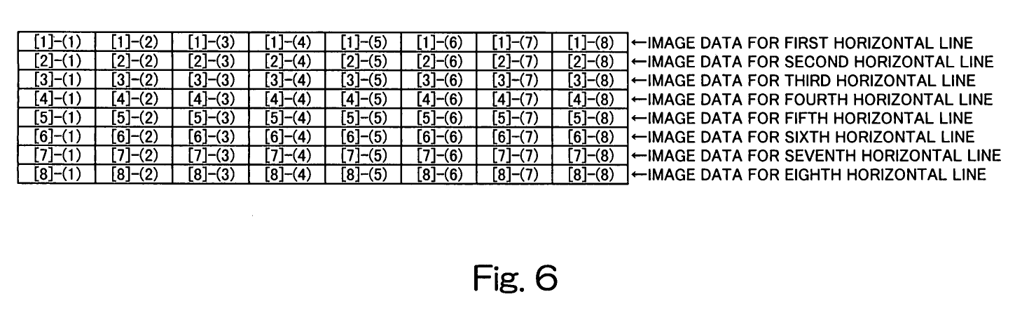

According to processings from step S12 to step S18, the image data from the first horizontal line to the eighth horizontal line is stored in the memory block 28. As shown in FIG. 6, the image data for the first horizontal line is stored from the memory unit 32 to which the tag [1]-(1) is allocated to the memory unit 32 of a group to which the tag [1]-(8) is allocated. Moreover, the image data for the second horizontal line is sequentially stored in the memory units 32 of groups to which tags from [2]-(1) to [2]-(8) are allocated. Similarly, the image data from the third horizontal line to the eighth horizontal line is stored in the memory units 32 of groups from [3]-(1) to [3]-(8) to [8]-(1) to [8]-(8).

When the next horizontal clock H is input to the counter 20, processing steps from step S20 downward are executed. At step S20, the count value of the counter 20 is increased by 1, a new tag is generated by the tag generation circuit 22, a tag is allocated to groups of the memory units 32. In this case, when there are empty memory units 32 in which image data is not stored in the memory block 28, these memory units 32 are grouped and a newly-generated tag is allocated to each group. When there is no empty memory unit 32, a newly-generated tag is allocated to a group in which image data already compressed by the JPEG processing circuit 30 is stored.

At step S22, JPEG-type compression processing is applied to the image data stored in the memory block 28. In the JPEG processing circuit 30, image data is read from the memory units 32 included in groups to which tags having the same group number are allocated over a plurality of horizontal lines to be collectively processed and the JPEG-type compression processing is applied to this image data. Image data is sequentially read from the memory unit 32 of the group to which the tag having the smallest group number is allocated, and is then processed.

At the same time, newly-received image data is stored in a group of the memory unit 32 to which a tag is newly allocated. That is, while compression processing is executed by the JPEG processing circuit 30, image data is newly received by the image signal receiving circuit 26 and the image data is stored by the memory unit 32 included in a group to which a tag is newly allocated at step S20 is stored. At this point, image data is sequentially stored from the group to which a tag having a smaller group number is allocated, as at step S16.

While the image data for one horizontal line is newly received and the image data for one horizontal line is stored in the memory block 28, it is preferable that real-time compression processing be applied to the image data stored in the memory unit 32 included in at least one group to which a tag of group number is allocated in the JPEG processing circuit 30. Thereby, it is possible to execute the real-time processing in which the receiving speed of an image signal is synchronized with the speed of the compression processing. When the processing applied to the image data stored in the memory unit 32 included in one group is completed, the processing returns to step S20.

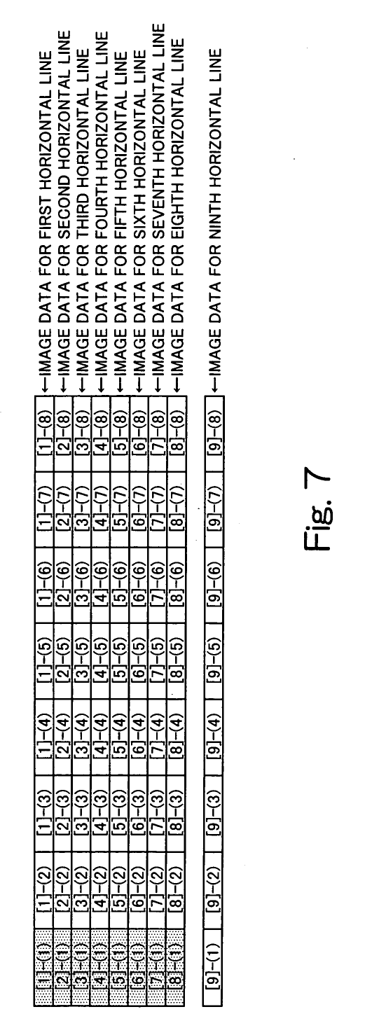

Processing steps S18 to S22 will next be described in detail. After the image data from the first eight horizontal lines is stored in the memory block 28 in step S18, the process continues on to step S20. At step S20, the count value is increased to 9 and tags from [9]-(1) to [9]-(8) are generated. Because the memory units 32 for one horizontal line in which image data is not stored remain in the memory block 28, empty memory units 32 are grouped and tags from [9]-(1) to [9]-(8) are allocated to each group as shown in FIG. 7. At step S22, the JPEG processing circuit 30 reads the image data for 8 longitudinal pixels×8 transverse pixels from the first pixel to the eighth pixel of from the first to eighth horizontal lines to be collectively processed from the memory units 32 included in groups specified by tags [1]-(1) to [8)-(1) and applies compression processing to those image data. At the same time, the image data for the ninth horizontal line is sequentially received by the image signal receiving circuit 26. The memory control circuit 24 stores the image data received by the image signal receiving circuit 26 in the memory units 32 included in groups to which tags [9]-(1) to [9]-(8) are allocated.

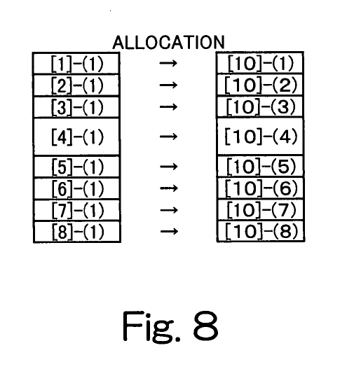

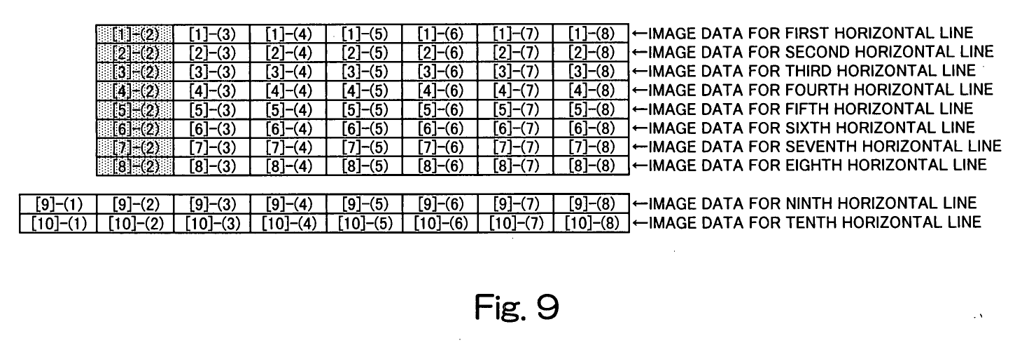

Before storage of the image data newly received by the memory units 32 of groups to which tags [9]-(1) to [9]-(8) are allocated is completed, compression processing is performed on the image data stored in the memory units 32 included in the first group, that is the memory units 32 of groups to which tags [1]-(1) to [8]-(1) are allocated. When the compression processing for the first group is completed, processing returns to step S20. At step S20, the count value is increased to 10 and tags [10]-(1) to [10]-(8) are newly generated. Because no memory unit 32 in the memory block 28 is empty, newly generated tags [10]-(1) to [10]-(8) are allocated to the memory units 32 included in groups to which tags (1]-(1) to [8]-(1) already compression-processed in step S22 are allocated as shown in FIG. 8. At step S22, as shown in FIG. 9, image data is read from the memory units 32 of the groups to which tags of the next group number, that is, tags [1]-(2) to [8]-(2) are allocated and compression processing is applied to those image data. At the same time, the image data for the tenth horizontal line are sequentially received by the image signal receiving circuit 26. The memory control circuit 24 stores the image data received by the memory units 32 of groups to which tags [10]-(1) to [10]-(8) are allocated.

Subsequently, and similarly, tags [11]-(1) to [11]-(8) are newly generated and tags [11]-(1) to [11]-(8) are newly allocated to the memory units 32 to which tags [1]-(2) to [8]-(2) are already allocated. Then, compression processing is applied to the image data stored in groups to which tags [1]-(3) to [8]-(3) are allocated and new image data is stored in the memory units 32 of groups to which tags [11]-(1) to [11]-(8) are newly allocated. Also thereafter, processing is applied to the image data stored in the memory units 32 of groups specified by the same group number to store newly received image data while re-allocating new tags to the memory units 32 of already processed groups.

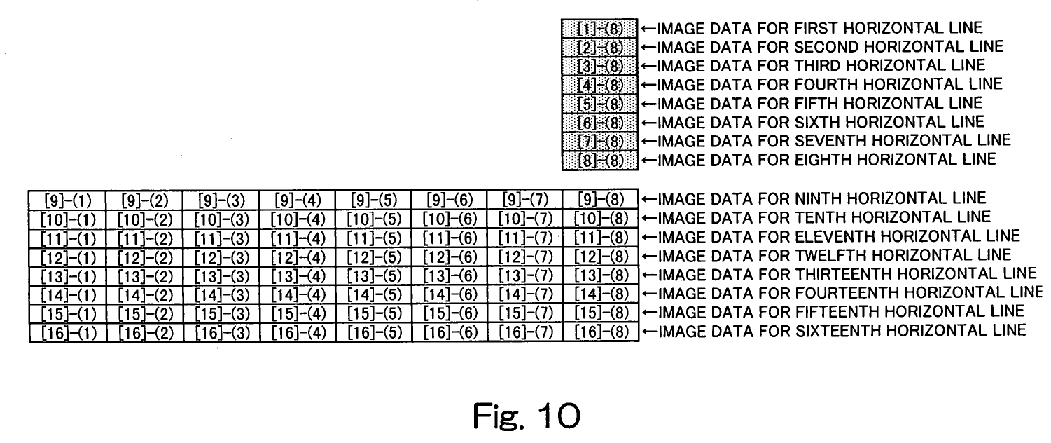

When the compression processing for all image data from the first horizontal line to the eighth horizontal line is completed, that is, when the compression processing to the image data stored in the memory units 32 of groups to which tags [1]-(8) to [8]-(8) are attached is completed, the count value of the counter 20 is increased up to 16 and as shown in FIG. 10, the image data from the ninth horizontal line to the sixteenth horizontal line is stored from the memory units 32 to which tags [9]-(1) to [9]-(8) are allocated to the memory units 32 to which tags [16]-(1) to [16]-(8) are allocated.

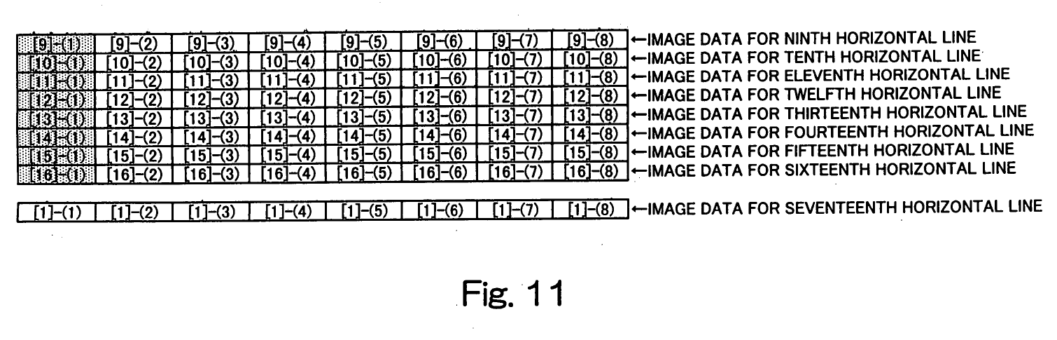

Then, when processing returns to step S20 again, the count value of the counter 20 is reset from 16 tol, and the tag generation circuit 22 generates new tags [1]-(1) to [1]-(8). Moreover, in step S22, as shown in FIG. 11, compression processing is applied to the image data stored in the memory units 32 of groups to which tags [9]-(1) to [16]-(1) are attached in the JPEG processing circuit 30 and, at the same time, newly generated tags [1]-(1) to [1]-(8) are allocated to the memory units 32 of groups to which tags [1]-(8) to [8]-(8) are already allocated and the image data for the seventeenth horizontal line is stored.

That is, each time a tag having a group number showing the sequence from the head of each horizontal line is allocated for each group and the processing to all image data held in memory units included in groups to which tags of the same group number among memory units in which image data for a predetermined number of horizontal lines is stored are allocated is completed, a newly-received image signal is stored in a memory unit in which already processed image data is stored. Thus, by dividing the memory units 32 for storing the image data for each horizontal line into groups of the number of horizontal lines to be collectively processed and using the memory units 32 included in the groups as a storage destination of newly-received image data when the processing of image signals for the stored image data for each group is completed, it is possible to reduce the total memory capacity necessary for image signal processing. By thus allocating a tag for specifying a horizontal line and group for every group of the memory unit 32 and processing the tag, memory management is simplified.

For example, when collectively applying the filter processing of a differential filter to image data for three horizontal lines, memory units 32 for four horizontal lines are prepared for the memory block 28. Then, one horizontal line is divided into a number of groups equal to the number of horizontal lines to be collectively processed, that is, three groups in the present example, and managed by allocating tags. Tags [1]-(1) to [1]-(3) are allocated to the first horizontal line, tags [2]-(1) to [2]-(3) . . . are allocated to the second horizontal line, and a tag of [4]-(3) is allocated to the fourth horizontal line. Thus, the present invention is not restricted to the JPEG processing of 8 longitudinal pixels×8 transverse pixels as in the example above. The present invention can be applied to other forms of image processing, as long as the image processing does not deviate from the basic idea of the present invention.

As described above, according to this embodiment, it is not necessary to use a memory block having a capacity two times or more larger than that of the number of horizontal lines serving as a processing unit to be collectively processed. It is possible to reduce the memory capacity required for real-time processing. As a result, it is possible to reduce the size of a circuit as compared to a conventional real-time processing circuit and to significantly reduce manufacturing costs.

1. An image signal processing apparatus for receiving an image signal continuously transmitted for every horizontal line and collectively applying processing to at least some portion of image data included in each of a predetermined number of two or more horizontal lines, comprising:
an image signal receiving circuit for receiving the image signal;
a memory including a memory unit having a capacity capable of storing and holding the image data for horizontal lines obtained by adding 1 to the predetermined number;
a memory control circuit for storing the image signal received by the image signal receiving circuit in the memory as image data; and
an image signal processing circuit for reading image data from the memory and processing the image data, wherein
each time the processing for the image data corresponding to the memory capacity for one horizontal line is completed in the image signal processing circuit, the memory control circuit stores an image signal newly received by the image signal receiving circuit in the memory unit in which the image data processed by the image signal processing circuit is stored.

2. The image signal processing apparatus according to claim 1, wherein
memory units in which image data for each horizontal line is stored are divided into groups, each group including a set specific number of memory units, the set specific number being calculated by dividing the number of pixels included in one horizontal line by the predeterminded number, and
the memory control circuit manages memories by allocating a specific tag for every group.

3. The image signal processing apparatus according to claim 2, wherein
the memory control circuit allocates, to every group, a tag having a group number showing a priority ranking within each horizontal line for the group of memory units, and
the memory control circuit stores an image signal newly received by the image signal receiving circuit in the memory unit in which the image data processed by the image signal processing circuit is stored each time the processing for all image data held in memory units included in groups to which tags of the same group number among the memory units in which the image data for the predetermined number of horizontal lines is stored are allocated has been completed.

4. The image signal processing apparatus according to claim 2, wherein
the memory control circuit allocates, to every group, a tag haing a group number showing a priority ranking within each horizontal line for the group of memory units, and
each time the processing for all image data held in memory units included in groups to which tags of the same group number among memory units in which the image data for the predetermined number of horizontal lines is stored are allocated is completed, the memory control circuit stores an image signal newly received by the image signal receiving circuit in a memory unit in which the image data processed by the image signal processing circuit is stored.

5. The image signal processing apparatus according to claim 2, wherein
the tag is constituted by a combination of a number for specifying each horizontal line and a group number for specifying each group.

6. An image signal processing method for receiving an image signal continuously transmitted for every horizontal line and collectively applying processing to at least some portion of image data included in each of a predetermined number of two or more horizontal lines, wherein
each time the processing for the image data corresponding to the memory capacity for one horizontal line is completed, a newly-received image signal is stored in a memory unit in which the processed image data is stored by using a memory including a memory unit having a capacity capable of storing and holding the image data for horizontal lines obtained by adding 1 to the predetermined number.

7. The image signal processing method according to claim 6, wherein
memory units in which image data for each horizontal line is stored are divided into groups, each group including a set specific number of memory units, the set specific number being calculated by dividing the number of pixels included in one horizontal line by the predeterminded number, and
a specific tag is allocated to each the group for memory management.
